(19) United States
(12) Patent Application Publication
(10) Pub. No.: US 2003/0208755 A1
(43) Pub. Date: Nov. 6, 2003

(54) Conversational content recommender

(75) Inventor: John Zimmerman, Ossining, NY (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V.

(21) Appl. No.: 10/136,965

(22) Filed: May 1, 2002

(51) Int. Cl. H04N 7/025; H04N 7/10; H04N 7/173; H04N 7/16

(52) U.S. Cl. 725/34; 725/135; 725/35; 725/112

(57) ABSTRACT

Disclosed is a method and system for providing conversational recommendations while viewing television programs. Accordingly, the present invention monitors incoming television signals to identify a particular sports team liked by a viewer according to a past viewing history. Then, at least one of predetermined conversational recommendations is retrieved when the sports team liked by the viewer is detected. The conversational recommendation is presented to the viewer in a conversational tone in view of the past performance by the sports team.

### BACKGROUND OF THE INVENTION

1. Field of the Invention

The present invention relates to a method and apparatus for recommending television programming and, more particular, to a method and apparatus for providing the viewer with conversational content recommendations based on a particular programming of interest.

2. Description of the Related Art

The modern world with huge amounts of multimedia gives television viewers a tremendous variety and range of options. Currently, there are over 500 different program channels shown through a cable television service. Online Internet services also offer a variety of different services to consumers, including electronic news, private message services, games, and other related downloadable services. As the number of channels available to television viewers has increased, along with the diversity of programming content available on such channels, it has become increasingly challenging for television viewers to identify television programs or retrieve information of their interests.

There are different types of television program guides that are available, i.e., the electronic program guides (EPGs), which allow television viewers to sort or search the available television programs in accordance with personalized preferences. The EPGs allow viewers to identify desirable programs more efficiently than conventional printed guides. As many viewers have a particular preference for or bias against certain categories of programming, such as the viewer's preferences, can be applied to the EPG to obtain a set of recommended programs that may be of interest to a particular viewer.

These TV show recommenders help users better manage the tremendous number of choices. However, users do not always trust that these recommenders work well or that they even have the user's best intentions in mind. Accordingly, the present invention provides a novel way of increasing trust in a recommender by having it presenting itself as being “on the same side” as the user and by reminding the user of a related event observed by both the user and the recommender in the past.

### SUMMARY OF THE INVENTION

The present invention is directed to a method and system for providing conversational content recommendations according to the past viewing history of a particular topic.

One aspect of the invention relates to a method for providing conversational comments and includes the steps of: detecting incoming television signals from a plurality of sources to identify a particular event or topic, such as a particular sports team, athlete, political race, or topical issue, liked by a viewer; retrieving at least one of predetermined conversational recommendations when the event liked by the viewer is detected; and, presenting the retrieved predetermined conversational recommendation to the viewer based on a past outcome of related events.

The topic liked by the viewer is determined based on the geographical location of the viewer, the frequency of watching a particular topic, and/or explicit user inputs. The past performance is obtained by either establishing a communication channel to a number of Internet sources to retrieve information relating to the topic liked by the viewer or by analyzing the video content of a liked topic program in order to determine the outcome of the event. The conversational recommendation is presented to the viewer in an audio signal, a textual signal, an image signal, a video signal or in combination thereof.

According to another aspect of the invention, a system for providing a conversational recommendation includes a detection means coupled to receive incoming television programs watched by a viewer, for identifying a particular topic liked by the viewer; a communication means for establishing a communication channel to a number of sources to retrieve information indicative of the particular topic liked by the viewer; a storage means for storing data representative of a plurality of predetermined conversational recommendations and for storing the retrieved information; and, a recommendation means, coupled to the storage means, the detection means, and the communication means, for presenting one of the predetermined conversational recommendations to the viewer based on a past performance by the identified topic. The system further includes a display means, coupled to the controlling means, for displaying the incoming television programs and one of the conversational recommendations in an audio signal, textual signal, a image signal, a video signal, and in combination thereof, and wherein the data representative of the plurality of the predetermined conversational recommendations is interactively created in advance. The topic program liked by the viewer is determined based on the geographical location of the viewer, the frequency of watching the particular topic, and/or explicit user input.

According to a further aspect of the invention, a system for providing a conversational recommendation includes a memory for storing a computer-readable code; and, a processor operatively coupled to the memory, the processor configured to: detect incoming television signals from a plurality of sources to identify a particular topic liked by a viewer according to a past viewing history; retrieve at least one of predetermined conversational recommendations when the topic liked by the viewer is detected; and, present the retrieved predetermined conversational recommendation to the viewer based on a past performance of the identified topic. The processor is further operative to: establish a communication channel to a number of Internet sources to retrieve information relating to the topic liked by the viewer; and, store the retrieved information in a storage medium for subsequent retrieval.

The foregoing and other features and advantages of the invention will be apparent from the following, more detailed description of preferred embodiments as illustrated in the accompanying drawings in which reference characters refer to the same parts throughout the various views. The drawings are not necessarily to scale; the emphasis instead is placed upon illustrating the principles of the invention.

### DETAILED DESCRIPTION OF THE DRAWINGS

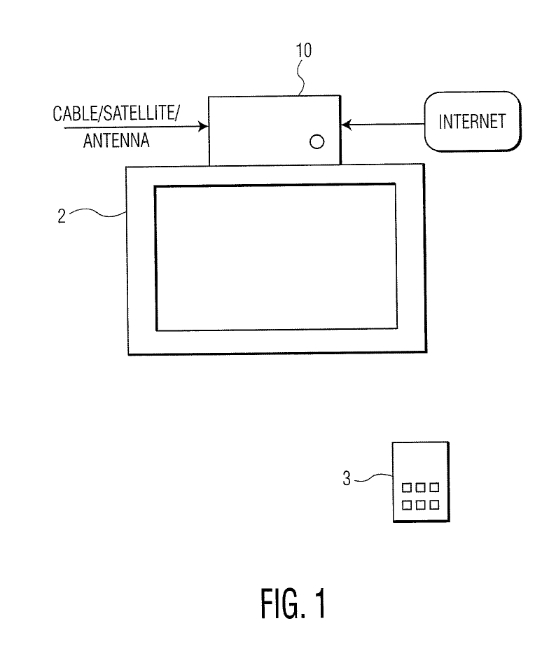

FIG. 1 is a simplified block diagram whereto the embodiment of the present invention may be applied;

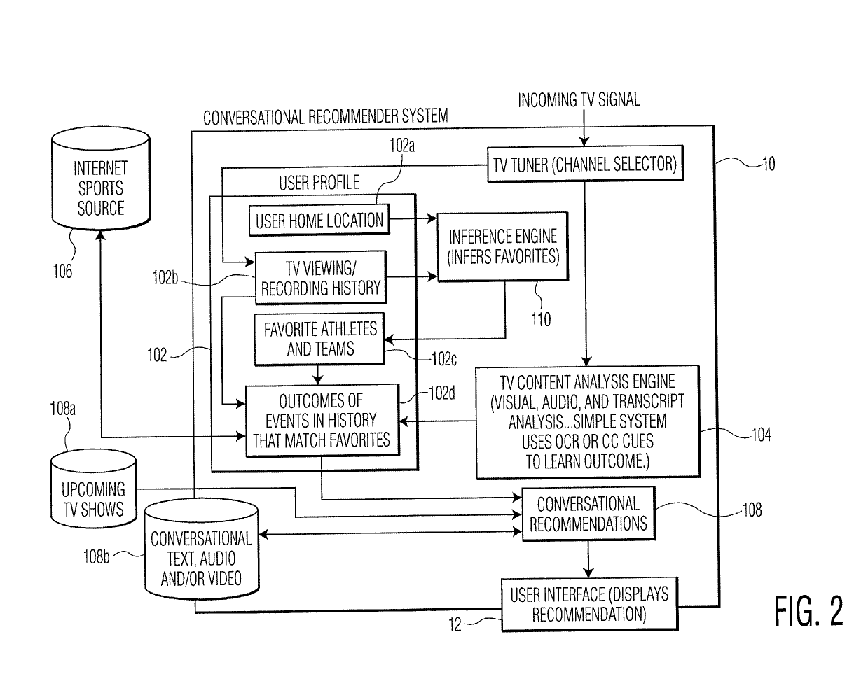

FIG. 2 is a simplified block diagram of the system capable of providing conversational content recommendations according an exemplary embodiment of the present invention;

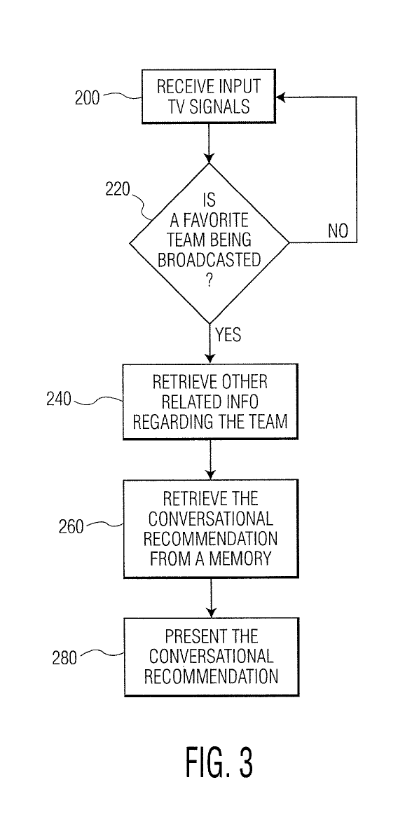

FIG. 3 is a flow chart illustrating the operation steps according to the present invention.

### DETAILED DESCRIPTION OF THE EMBODIMENTS

In the following description, for purposes of explanation rather than limitation, specific details are set forth such as the particular architecture, interfaces, techniques, etc., in order to provide a thorough understanding of the present invention. However, it will be apparent to those skilled in the art that the present invention may be practiced in other embodiments, which depart from these specific details. Moreover, for the purpose of clarity, detailed descriptions of well-known devices, circuits, and methods are omitted so as not to obscure the description of the present invention with unnecessary detail.

Referring to FIG. 1, a preferred embodiment of the present invention is a receiver system 10, which is capable of providing conversational content recommendations. The system 10 is configured to receive audio and video programming from the Internet and the conventional television (TV) broadcast as well as a variety of other sources, including a cable service provider, digital high definition television (HDTV) and/or digital standard definition television (SDTV) signals, a satellite dish, a conventional RF broadcast, an Internet connection, or another storage device, such as a VHS player or DVD player. The audio and video programming can be delivered in analog, digital, or digitally compressed formats via any transmission means, including satellite, cable, wire, television broadcast, or sent via the Web. It should be noted that the present system is also capable of being connected to other possible networks, such as a direct private network and a wireless network. Alternatively, the receiver system 10 may be coupled to a personal computer system (not shown) to receive the Internet content from a particular web server via a high-speed line, RF, conventional modem, or a two-way cable carrying the video programming. A remote controller 3 is also provided to issue command signals to the inventive system 10 as occasion demands.

FIG. 2 is a block diagram illustrating a receiver system 10 in accordance with this embodiment of the invention. It should be noted that the receiver system 10 can be implemented in a variety of combinations of software and hardware devices. By way of example, the conversational content recommender 10 would comprise a central processing unit (CPU) with one or more memory devices and includes a user profile 102, a TV content analysis engine 104, a internet source 106, a conversational recommendation module 108, and an inference engine 110. The user profile 102 further includes a user home location module 102(a) for storing information relating to the user's home location, a TV viewing history module 102(b) for storing past viewing history of the user, a favorite topic module 102(c) for storing user's favorite topics, such as favorite athletes and teams; and an outcome history module 102(d) for storing outcomes of events that match favorite topic. The user profile 102 may be stored in a read/write non-volatile memory device, such as a disk. The outcome history module 102(d) is equipped with a web browser to make a connection to the Internet source 106 to retrieve a particular web content. The web content, including all the applications and the HTML format, may be downloaded and saved in the outcome history module 102(d) for subsequent retrieval. It is noted that any number of commercially or publicly available browsers can be utilized in various implementations in accordance with the preferred embodiment of the present invention. For example, a browser such as Netscape™ (a trademark of Netscape, Inc.) can be utilized in accordance with a preferred embodiment of the present invention to provide the functionality specified under HTTP.

In operation, the receiver system 10 monitors a number of programs that are watched by the viewer to determine a set of programs, i.e., sports programs that may be of interest to a particular viewer over time. Thereafter, the system 10 infers a set of programs that are favored by the viewer based on the past viewing behavior and the geographical location of the viewer's residence. The inference engine 110 takes the user's home location 102(a) and TV viewing history 102(b) as inputs. The inference engine 110 checks to see if any specific athletes or teams appear to dominate the sports content a user watches. The inference engine 110 slightly favors athletes and teams that are close to the user while inferring which teams and/or athletes a user is routing for. It should be noted that although the exemplary embodiment is described using sports as example, the inventive system 10 can work for other kinds of TV content, such as politics and issues, where users pick sides, in accordance with the technique of the present invention. Therefore, the system 10 can infer which side of a controversy, issue, or political race the user is on.

A list of sports programs favored by the viewer is stored in the favorite topic module 102(c) for subsequent comparison. The information related to the residence may be obtained in advance from a registration process. Meanwhile, obtaining the user profile 102 based on the viewing history 104 can be performed in a variety of ways. See for example, PCT WO 01/45408 (Gutta) that is assigned to the same assignee, and the content of which is hereby incorporated by simple reference. Gutta uses inductive principles to identify a set of recommended programs that may be of interest to a particular viewer, based on the past viewing history of a user. To this end, the system monitors a user's viewing history and analyzes the shows that are actually watched by a user (positive examples) and the shows that are not watched by the user (negative examples). For each positive and negative program example (i.e., programs watched and not watched), a number of program attributes are classified in the user profile, such as the time, date, duration, channel, rating, title, and genre of a given program. Then, these various attributes are used to generate a decision tree. Thus, based on the user's viewing pattern, a database reflecting the user's likes or dislikes of various program contents can be obtained. Alternatively, another way of making the inference is by using a Bayesian classifier. This statistical based machine learning technique looks at different variables, such as teams and athletes, and waits to see which ones standout above a noise threshold. In this case the classifier can give slightly higher weights to local teams and athletes.

In summary, the topic liked by the viewer is determined in one of five ways: 1) Users can explicitly tell the system which topics they are interested in. For example, a user might tell the system to record all programs involving the New York Jets football team; 2) The system can infer what users like by analyzing their viewing history. For example, the system may notice that the user is much more likely to watch a football game if the New York Jets are playing; 3) The system can use the user's geographical locations. For example, if the system knows the user lives in the Bronx, it may infer that the user likes the New York Yankees who are also located in the Bronx; 4) The system can use both geographical location and viewing history together to infer a liked topic; and, 5) When the system is sure of a topic but not of a specific point of view, it can explicitly ask the user. For example, when a user asks the system to record all TV programs about the New York Senate race, the system can ask the user if there is a specific candidate they are supporting. In such a system, default criteria would be automatically set with the viewer having an option of modifying them.

Once the type of sports team preferred by the viewer based on the geographical location and the viewing habit of a given viewer is determined, the inferred favorite teams and athletes are then passed to the favorites list. When a new item is added to the favorites list, the system 10 attempts to learn outcomes of events involving the favorites that the user has watched. The system 10 knows what the viewer has seen from the view history 102(b). For current events the system 10 can learn outcomes in three ways: (i) It can query web sites as it did for past events; (ii) It can subscribe to a third party service that provides these details; and, (iii) it can analyze the incoming video stream. Two simple ways to extract the out come of a sporting event involve (i) monitoring the closed captions text and/or (ii) performing OCR (Optical Character Recognition) on the screen text. That is, the system 10 retrieves various types of information, i.e., scores from the previous games, statistics, play schedules, updates on individual players, etc., of a particular sports team using the web connection from the Internet source 106. The content of game scores may be obtained using a well-known OCR operation on the texts shown in the video stream from the TV content analysis engine 104. The browser provided in the receiver system 10 is activated to establish a web connection to the Internet via the Internet interface 106. The web connection also can be made to a proxy, or an unaffiliated third party providing the interactive capability. The information of the sports team liked by the user is downloaded and stored in the outcome history module 102(d) of the receiver system 10.

Information relating to upcoming TV shows 108(a) may be received from an external source. The conversational module 108(b) also stores a plurality of conversational content recommendations so that the conversational recommender 108 can provide different types of conversational recommendations interactively based on the past outcome of the game. To this end, an index table having entries for a plurality of inputs and output responses is stored in the memory. The system 10 will search to find a correlation between attributes of the viewer's favorite team and attributes of pre-recorded conversational content phrases. Hence, depending on the status of inputs, which is determined based on the information downloaded from a various sources, index table points to a particular output response.

Thereafter, the system 10 monitors new programs by checking EPG metadata from an external source. When it sees a program it wants to recommend that involves a favorite team or athlete with outcome history, the system 10 selects a conversational sentence that recommends this event. The sentence contains the following elements: (i) It communicates to the user that both the system 10 and the user are cheering for the same team. (ii) It acknowledges a previous outcome in that matches the viewing history, creating the illusion that the system 10 and the user had a shared event when they both watched the previous match/game. For example, if team A was defeated by team B in the last game and if team A is a home team near the viewer's residence, the system 10 will infer that team A is the viewer's favorite team. As such, if a game between the teams A and B is being broadcast, the recommender 100 will transmit a message, for example: “Do you think our team A will win this time?” Other prerecorded statements can be stored by the operator, such that the various statements can be composed relating to a particular team and presented to the viewer in text or audio messages, or in combination. Accordingly, the “conversational content recommendations” may be retrieved automatically by the receiver system 10 and presented to the viewer at the time its associated sports program is broadcast. The creation of the shared experience and the implication that the system is on the same side as the team is designed to build trust not only for this specific recommendation, but for all recommendations made by the system 10. It should be noted that the conversational sentences can be contained on the system 10 or at an external location, thus the system 10 can by-pass recommending operation by using a third party service. The system would feed this service the liked team/athlete inference and the viewing history of events involving this person/team. The third party service would then provide the appropriate conversational recommendation.

FIG. 3 is a flow diagram illustrating the operation steps performed by the present invention. The chosen embodiment of the present invention is a software executed within the system 10. Computer programs (or computer control logic) are stored in the memory. Such computer programs, when executed, enable the computer system to perform the function of the present invention as discussed herein. The rectangular elements indicate computer software instruction, whereas the diamond-shaped element represents computer software instructions that affect the execution of the computer software instructions represented by the rectangular blocks. Alternatively, the processing and decision blocks represent steps performed by functionally equivalent circuits such as a digital signal processor circuit or an application-specific integrated circuit (ASIC). The flow diagrams do not depict the syntax of any particular programming language. Rather, the flow diagrams illustrate the functional information that one of ordinary skill in the art requires to fabricate circuits or generate computer software to perform the processing required of the particular apparatus.

Upon receiving the incoming TV signals from a cable service provider, antenna, or satellite service in step 200, the receiver system 10 detects whether the incoming TV broadcast signals correspond to one of the favorite sports teams liked by the viewer in step 220. Here, the sports teams preferred by the viewer are determined based on the geographical location of the viewer's residence and the past viewing history. The system 10 searches the viewing history to discover that a particular team appears often in previously watched programs. At the same time, if the team is located close to the viewer's residence, the system 10 makes an inference that particular team is the viewer's favorite team. If the sports team favored by the viewer is detected, information regarding the favored team is retrieved in step 240, then a number of pre-recorded conversational content phrases are retrieved from the memory 108 in step 260. By way of another example, the system 10 determines the viewer likes to watch a NFL football team, “Jets”, often based on the viewer's history. It looks at such viewing history and the viewer's residence, then learns that the viewer's favorite football team is “Jets”. The system 10 also learns “Jets” is playing in a playoff game with “Raiders” this weekend through the “NFL website”. The system 10 then transmits a number of conversational recommendations in text or audio, or in combination to the viewer that relates to the upcoming event, in step 280.

Having thus described a preferred embodiment of a method and system for providing a number of conversational recommendations in a digital TV environment, it should be apparent to those skilled in the art that certain advantages of the system have been achieved. The foregoing is to be constructed as only being an illustrative embodiment of this invention. Persons skilled in the art can easily conceive of alternative arrangements providing a functionality that is similar to this embodiment without any deviation from the fundamental principles or the scope of this invention.

What is claimed is:

1. A method for providing conversational comments, the method comprising the steps of:
detecting incoming television signals from a plurality of sources to identify a particular topic liked by a viewer according to a past viewing history;
retrieving at least one of predetermined conversational recommendations when the topic liked by said viewer is detected; and,
presenting said retrieved predetermined conversational recommendation to said viewer based on a past performance by said identified topic.

2. The method of claim 1, further comprising the step of obtaining a geographical location of said viewer.

3. The method of claim 1, wherein the topic liked by said viewer is determined based on a geographical location of said viewer and a frequency of watching said particular topic.

4. The method of claim 1, wherein said retrieved predetermined conversational recommendation is presented to said viewer in an audio signal, a textual signal, an image signal, a video signal, and in combination thereof.

5. The method of claim 1, wherein said past performance is obtained by:
establishing a communication channel to a number of Internet sources to retrieve information relating to said topic liked by said viewer; and,
storing said retrieved information in a storage medium for subsequent retrieval.

6. The method of claim 1, wherein said retrieved predetermined conversational recommendation is presented to said viewer in a conversational tone.

7. The method of claim 1, wherein said plurality of sources includes at least one of a television network, Internet network, wireless network, and wired network, or a combination thereof.

8. A method for providing a conversational content, the method comprising the steps of:
obtaining a viewing history of past programs watched by a viewer;
generating a user profile for said viewer indicative of a frequency of a particular program watched by said viewer;
determining a number of programs preferred by said viewer based on a geographical location of said viewer and the frequency of a particular program watched by said viewer; and,
presenting at least one of predetermined conversational recommendations to said viewer based on a past performance by one of said program liked by said viewer.

9. The method of claim 1, wherein at least one of said predetermined conversational recommendation is presented to said viewer in an audio signal, a textual signal, an image signal, a video signal, and in combination thereof.

10. The method of claim 1, wherein said past performance is obtained by:
establishing a communication channel to a number of Internet sources to retrieve information relating to said program liked by said viewer; and,
storing said retrieved information in a storage medium for subsequent retrieval.

11. The method of claim 1, wherein said retrieved predetermined conversational recommendation is presented to said viewer in a conversational tone.

12. The method of claim 8, wherein said user profile is created interactively in response to said viewer's input.

13. A system for providing a conversational recommendation comprising:
a detection means, coupled to receive incoming television programs watched by a viewer, for identifying a particular program liked by a viewer according to a past viewing history;
a communication means for establishing a communication channel to a number of sources to retrieve information indicative of said particular program liked by said viewer;
a storage means for storing data representative of a plurality of predetermined conversational recommendations and for storing said retrieved information; and,
a recommendation means, coupled to said storage means, said detection means, and said communication means, for presenting one of said predetermined conversational recommendations to said viewer based on a past events related to said particular program.

14. The system of claim 13, further comprising a display means, coupled to said recommendation means, for displaying said incoming television programs and one of said conversational recommendations in an audio signal, a textual signal, a video signal, an image signal, and in combination thereof.

15. The system of claim 13, wherein the data representative of the plurality of said predetermined conversational recommendations is interactively created in advance.

16. The system of claim 13, wherein said retrieved predetermined conversational recommendation is presented to said viewer in a conversational tone.

17. The system of claim 1, wherein the program liked by said viewer is determined based on a geographical location of said viewer and a frequency of watching said particular program.

18. A system for providing a conversational recommendation comprising:
a memory for storing a computer-readable code; and,
a processor operatively coupled to said memory, said processor configured to:
detect incoming television signals from a plurality of sources to identify a particular program liked by a viewer according to a past viewing history;
retrieve at least one of predetermined conversational recommendations when the program liked by said viewer is detected; and,
present said retrieved predetermined conversational recommendation to said viewer based on a past performance by said identified program.

19. The system of claim 18, wherein the program liked by said viewer is determined based on the geographical location of said viewer and the frequency of watching said particular program.

20. The system of claim 18, wherein said retrieved predetermined conversational recommendation is presented to said viewer in an audio signal, a textual signal, a video signal, an image signal, and in combination thereof.

21. The system of claim 18, wherein said processor is further operative to:
establish a communication channel to a number of Internet sources to retrieve information relating to said program liked by said viewer; and,
store said retrieved information in a storage medium for subsequent retrieval.

22. The system of claim 1, wherein said retrieved predetermined conversational recommendation is presented to said viewer in a conversational tone.
